(19) United States
(12) Patent Application Publication
(10) Pub. No.: US 2026/0014542 A1
(43) Pub. Date: Jan. 15, 2026

(54) BONE CHAR ABSORBENT FOR ADSORBING ARSENIC AND METHOD OF MANUFACTURING THE SAME

(71) Applicant: NATIONAL CHENG KUNG UNIVERSITY, Tainan City (TW)

(72) Inventors: Wei-Hsin CHEN, Kaohsiung City (TW); Partha Pratim BISWAS, Tainan City (TW)

(21) Appl. No.: 18/929,583

(22) Filed: Oct. 28, 2024

(30) Foreign Application Priority Data
Jul. 11, 2024 (TW) 113125937

(51) Int. Cl. B01J 20/20; B01J 20/30

(52) U.S. Cl. CPC B01J 20/20; B01J 20/3078; B01J 2220/4812

(57) ABSTRACT

A method of manufacturing a bone char absorbent includes the following steps. A drying step is performed on an initial bone material to form dried bone material. A torrefaction step or a co-torrefaction step is performed on the dried bone material to form torrefied bone material or a co-torrefied mixture, in which the torrefaction step and the co-torrefaction are performed at a heating rate of 10° C./min to 20° C./min to a torrefied temperature or a co-torrefied temperature of 175° C. to 300° C. for 15 minutes to 60 minutes. A cooling step is performed on the torrefied bone powders or the co-torrefied mixture to form the bone char absorbent. The mineral phase of the bone char absorbent includes carbonated hydroxyapatite, thereby enhancing the adsorption capacity for trivalent arsenic ions.

### CROSS-REFERENCE TO RELATED APPLICATION

This application claims priority to Taiwan Application Serial Number 113125937, filed Jul. 11, 2024, which is herein incorporated by reference in its entirety.

### BACKGROUND

### Field of Invention

The present disclosure relates to a bone char absorbent for adsorbing arsenic and a method of manufacturing the same. More particularly, the present disclosure relates to a bone char absorbent with improved adsorption capacity (sorption capacity) for trivalent arsenic ions and a method of manufacturing the same.

### Description of Related Art

Arsenic is a substance harmful to the human body. If humans drink drinking water containing arsenic for a long time, it can cause multiple organ disorders, including skin conditions, and lead to cancer. According to the World Health Organization, the safety standard value for arsenic is 0.01 mg/L. Bangladesh is the country most severely affected by arsenic contamination, with the arsenic concentration in its groundwater reaching as high as 0.2 mg/L.

Bone char absorbents can solve the problem of arsenic contamination. It is known that bone char absorbents are obtained by the high-temperature pyrolysis method at temperatures between 400° C. and 1000° C. However, the high operating temperature not only increases energy consumption but also increases the release of carbon dioxide in the reaction system due to high air pressure. In addition, the organic components in bone materials usually decompose at temperatures between 400° C. and 600° C. to produce carbon dioxide. Therefore, the high-temperature pyrolysis method can increase the release of carbon dioxide. The known method of manufacturing bone char absorbents is not only environmentally unfriendly but also prone to causing air pollution. Furthermore, bone char absorbents obtained by the high-temperature pyrolysis method have poor adsorption capacity for arsenic.

Therefore, there is a need to develop a bone char absorbent for adsorbing arsenic made by low temperature (torrefaction or co-torrefaction) and a method of manufacturing the same to solve the above problems.

### SUMMARY

The method of manufacturing the bone char absorbent of the present disclosure controls a low torrefied temperature/co-torrefied temperature of 175° C. to 300° C. Compared with the high-temperature pyrolysis method, the method of manufacturing the bone char absorbent is energy-saving, environmentally friendly, cost-effective, and highly efficient.

The mineral phase of the bone char absorbents (i.e., torrefied/co-torrefied bone chars) includes carbonated hydroxyapatite. In an acidic solution, vacancies are formed due to the release of carbonate and calcium ions out of the chemical structure of the carbonated hydroxyapatite. Arsenic ions can then occupy these vacancies and form ionic bonds with phosphate, thereby achieving the effect of arsenic sorption.

At least one embodiment of the present disclosure provides a method of manufacturing a bone char absorbent, which includes the following steps. A drying step is performed on an initial bone material to form a dried bone material. A torrefaction step is performed on the dried bone material to form a torrefied bone material, in which the torrefaction step is performed at a heating rate of 10° C./min to 20° C./min to a torrefied temperature of 175° C. to 300° C. for 15 minutes to 60 minutes. A cooling step is performed on the torrefied bone material to form the bone char absorbent.

In at least one embodiment of the present disclosure, a raw material of the initial bone material is a cattle bone or a pig bone.

In at least one embodiment of the present disclosure, a mean diameter of the initial bone material is 1 mm to 2 mm.

In at least one embodiment of the present disclosure, a drying temperature of the drying step is 50° C. to 100° C.

In at least one embodiment of the present disclosure, a drying time of the drying step is 20 hours to 24 hours.

In at least one embodiment of the present disclosure, the torrefaction step is performed at a heating rate of 15° C./min to the torrefied temperature of 300° C. for 30 minutes.

In at least one embodiment of the present disclosure, the torrefied temperature in the torrefaction step is 238° C.

In at least one embodiment of the present disclosure, the cooling step is natural cooling.

In at least one embodiment of the present disclosure, a carbonate content of the bone char absorbent accounts for 13% to 22% of the bone char absorbent.

At least one embodiment of the present disclosure provides a bone char absorbent for adsorbing arsenic, in which the bone char absorbent is manufactured by the manufacturing method mentioned above, an adsorption capacity of the bone char absorbent for trivalent arsenic ion in an arsenic solution is at least 2.5 mg per gram, a pH value of the arsenic solution is between 3.5 and less than 7, and an arsenic concentration of the arsenic solution is 25 mg/L.

At least one embodiment of the present disclosure provides a method of manufacturing a bone char absorbent, which includes the following steps. A drying step is performed on the initial bone material to form a dried bone material. A co-torrefaction step is performed on a mixture of the dried bone material and a biomass to form a co-torrefied mixture, in which the co-torrefaction step is performed at a heating rate of 10° C./min to 20° C./min to a co-torrefied temperature of 175° C. to 300° C. for 15 minutes to 60 minutes. A cooling step is performed on the co-torrefied mixture to form the bone char absorbent.

In at least one embodiment of the present disclosure, the biomass includes hemicellulose.

In at least one embodiment of the present disclosure, a weight ratio of the dried bone material to the biomass is 1:5 to 1:15 in the co-torrefaction step.

In at least one embodiment of the present disclosure, the weight ratio of the dried bone material to the biomass is 1:10 in the co-torrefaction step.

In at least one embodiment of the present disclosure, a drying temperature of the drying step is 50° C. to 100° C., and a drying time of the drying step is 20 hours to 24 hours.

In at least one embodiment of the present disclosure, the co-torrefaction step is performed at the heating rate of 15° C./min to the co-torrefied temperature of 300° C. for 30 minutes.

In at least one embodiment of the present disclosure, the torrefied temperature in the co-torrefaction step is 238° C.

In at least one embodiment of the present disclosure, the cooling step is natural cooling.

In at least one embodiment of the present disclosure, a carbonate content of the bone char absorbent accounts for 12% to 13% of the bone char absorbent.

At least one embodiment of the present disclosure provides a bone char absorbent for adsorbing arsenic, in which the bone char absorbent is manufactured by the manufacturing method mentioned above, an adsorption capacity of the bone char absorbent for trivalent arsenic ion in an arsenic solution is at least 2.5 mg per gram, a pH value of the arsenic solution is between 3.5 and less than 7, and an arsenic concentration of the arsenic solution is 25 mg/L.

### BRIEF DESCRIPTION OF THE DRAWINGS

The invention can be more fully understood by reading the following detailed description of the embodiment, with reference made to the accompanying drawings as follows:

FIG. 1 is a flow chart of a method of manufacturing a bone char absorbent in accordance with one aspect of the present disclosure;

FIG. 2 is a flow chart of a method of manufacturing a bone char absorbent in accordance with another aspect of the present disclosure;

FIG. 3 was a schematic diagram illustrating the relative effect of process factors parameters (including the heating rate, the co-torrefied temperature, and the additive amount of biomass) in accordance with some embodiments of the present disclosure;

FIG. 4 was a bar chart illustrating C₀-C_{f} in Example 8 and Example 10;

FIG. 5 was a graph illustrating the results of Sample S1 to Sample S9 in Example 1 to Example 9 respectively before the arsenic adsorption experiment under ATR-FTIR to observe the carbonate contained in Sample S1 to Sample S9; and

FIG. 6 was a graph illustrating the result of Sample S10 in Example 10 before the arsenic adsorption experiment under ATR-FTIR to observe the carbonate contained in Sample S10.

### DETAILED DESCRIPTION

The manufacturers and uses of embodiments of the present disclosure are discussed in detail below. However, it is to be understood that the embodiments provide many applicable inventive concepts that can be embodied in a wide variety of specific contexts. The specific embodiments discussed are illustrative only and are not intended to limit the scope of the present disclosure.

In the present disclosure, the range expressed by “one value to another value” is a summary expression that avoids enumerating all the values in the range one by one in the specification. Therefore, the description of a specific range covers any value within that numerical range and a smaller numerical range bounded by any numerical value within that numerical range. It is the same as the arbitrary numerical value and the smaller numerical range is expressly written in the specification.

The terms “about,” “approximately,” “essentially,” or “substantially,” as used herein, include the stated value and the average value within an acceptable range of deviation as determined by one of ordinary skill in the art, considering the specific quantity discussed and the errors associated with the measurement (i.e., limitations of the measurement system). For example, “about” can refer to being within one or more standard deviations of the stated value, or within, for example, ±30%, ±20%, ±15%, ±10%, or ±5%.

In 2021, Alkurdi et al. published an article titled “Inorganic arsenic species removal from water using bone char: A detailed study on adsorption kinetic and isotherm models using error functions analysis” in the Journal of Hazardous Materials, Volume 405, Page 124112 (hereinafter is referred to as Alkurdi). In Alkurdi, a sheep bone is pyrolyzed at 900° C. to form a bone char. The adsorption capacity of the bone char for trivalent arsenic ion in an arsenic solution is at about 0.07 mg per gram. The mineral phase of bone char after pyrolysis is hydroxyapatite (HAp), with the chemical formula Ca₁₀(PO₄)₆(OH)₂. It is now understood that during the pyrolysis of bone char with carbon dioxide, the carbonate generated in the process fully decomposes at temperatures above 700° C. Therefore, the mineral phase produced by Alkurdi does not include carbonate.

The method of manufacturing the bone char absorbent of the present disclosure uses a torrefaction method or a co-torrefaction method to perform a heat treatment on an animal bone. The mineral phase of the obtained torrefied bone char or co-torrefied bone char is carbonated hydroxyapatite (CHAp). CHAp can be categorized into A-type CHAp and B-type CHAp, as shown in the formula (I) and the formula (II) below.

A-type CHAp:

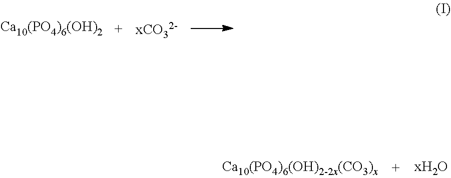

In the formula (I), x is a positive integer, and x is in a range from 0 to 2.

B-type CHAp:

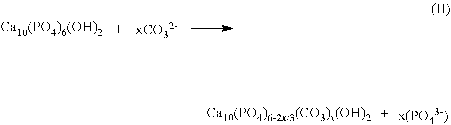

In the formula (II), x is a positive integer, and x is in a range from 0 to 6.

The above-carbonated hydroxyapatite also can be referred to as “carbonate substitution.”

Compared with the disclosure in Alkurd, the mineral phase of the present torrefied bone char or co-torrefied bone char contains carbonate (CO₃²⁻). When the torrefied bone char or co-torrefied bone char in the arsenic solution with a pH value less than 7, the carbonate and calcium ions in the mineral phase (i.e., carbonated hydroxyapatite) are dissolved and form vacancies. When carbonate and calcium ions are released out of the chemical structure of carbonated hydroxyapatite, arsenic ions can occupy these vacancies in the chemical structure and form ionic bonds with phosphate, thereby adsorbing arsenic ions in the arsenic solution. The arsenic ion in the arsenic solution includes trivalent arsenic ion (As³⁺) and pentavalent arsenic ion (As⁵⁺). The ionic radii of trivalent arsenic ion and pentavalent arsenic ion are approximately 0.058 nm and 0.046 nm respectively. Since ionic radii of trivalent arsenic ion and pentavalent arsenic ion are smaller than that of calcium, both trivalent arsenic ion and pentavalent arsenic ion can fill the vacancies of calcium and be adsorbed by carbonated hydroxyapatite. In addition, the disclosed torrefied bone char or co-torrefied bone char has low crystallinity and therefore can be easily dissolved in the solution.

In other words, compared with hydroxyapatite without carbonate, the disclosed carbonated hydroxyapatite containing carbonate has more opportunities to adsorb arsenic. Therefore, the arsenic adsorption capacity of the disclosed bone char absorbent is superior to that of Alkurdi.

The “bone char absorbent” in the present disclosure refers to the torrefied bone char or co-torrefied bone char obtained by performing the torrefaction step or co-torrefaction step on a bone material (also known as a “bone chunk” or “bone particle”). The bone char absorbent in the present disclosure can be used to adsorb heavy metals (arsenic ions) in wastewater. Since the ionic radii of cadmium, palladium, and zinc are smaller than that of calcium, the disclosed bone char absorbent can also be used to adsorb heavy metals such as cadmium, palladium, and zinc in wastewater.

The “torrefaction” in the present disclosure refers to the torrefaction step applied to the bone material, in which the torrefied temperature is 175° C. to 300° C. The “co-torrefaction” in the present disclosure refers to the co-torrefaction step applied to the bone material and the biomass, in which the co-torrefied temperature is 175° C. to 300° C.

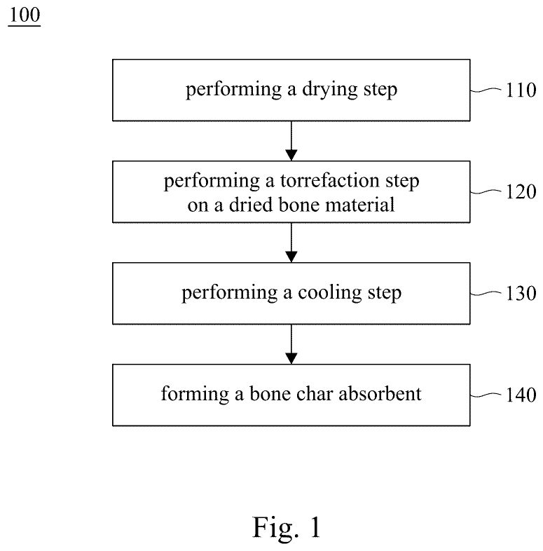

FIG. 1 is a flow chart of a manufacturing method 100 of a bone char absorbent in accordance with one aspect of the present disclosure. As shown in a step 110 of FIG. 1, performing a drying step on an initial bone material to form a dried bone material.

In some embodiments, the initial bone material is obtained by performing a crushing step on an animal bone. In some embodiments, before performing the crushing step, perform a cleaning step, which uses clean water to clean the animal bone.

In some embodiments, a raw material of the initial bone material is a cattle bone or a pig bone. The chemical compositions of the cattle bone and pig bone are similar, consisting of approximately 80% hydroxyapatite and the rest as organic compounds. The higher content of hydroxyapatite in the initial bone material helps to form the disclosed bone char absorbent with a high adsorption capacity for arsenic.

In some embodiments, a mean diameter of the initial bone material is 1 mm to 2 mm. When the mean diameter is 1 mm to 2 mm, the obtained bone char absorbent can easily separate from the solution after the sorption experiment.

In some embodiments, a drying temperature of the drying step is 50° C. to 100° C., such as 60° C., 70° C., 80° C., or 90° C. The purpose of drying is to remove the water used in cleaning the animal bone. When the drying temperature is between 50° C. and 100° C., no chemical changes occur in the bone material.

In some embodiments, a drying time of the drying step is 20 hours to 24 hours, such as 21 hours, 22 hours, or 23 hours. When the drying time is under the condition of 20 hours to 24 hours, the bone material can be completely dried without any moisture remaining in the bone material.

Next, as shown in a step 120 of FIG. 1, performing a torrefaction step on the dried bone material to form a torrefied bone material, in which the torrefaction step is performed at a heating rate of 10° C./min to 20° C./min to a torrefied temperature of 175° C. to 300° C. for 15 minutes to 60 minutes. In some embodiments, the heating rate in the torrefaction step is 15° C./min. In some embodiments, the torrefied temperature in the torrefaction step is 238° C. In some embodiments, the holding time in the torrefaction step is 30 minutes. In one specific embodiment, the torrefaction step is performed at the heating rate of 15° C./min to the torrefied temperature of 300° C. for 30 minutes. The slower the heating rate, the longer the total time spent for torrefaction. On the contrary, the faster the heating rate, the shorter the total time spent.

If the heating rate was less than 15° C./min, it would take more time to reach the required temperature. This increases the time for manufacturing the bone char absorbent, thereby increasing production costs.

If the torrefied temperature was less than 175° C., the carbonate substitution in the bone char matrix (i.e., hydroxyapatite) of the bone char absorbent may be little or absent. Since the carbonate content in bone char is very little, the carbonate is hardly dissolved in the acidic solution, so calcium and carbonate ions are not released to form sufficient vacancies for arsenic sorption. The calcium and carbonate ions in the bone char absorbent decrease as the torrefied temperature increases. If the torrefied temperature was greater than 300° C., carbonate would decompose into carbon dioxide and steam at high temperatures, so the carbonate in the bone char absorbent would become less. When the carbonate ions in the bone char absorbent are reduced, the chemical structure of carbonated hydroxyapatite also has fewer vacancies in the acidic solution, thereby reducing the adsorption capacity of the bone char absorbent for arsenic.

If the holding time in the torrefaction step was less than 15 minutes, the carbonate substitution in the bone char matrix of the bone char absorbent may be reduced due to the shorter decomposition time of the organic components. If the holding time in the torrefaction step was greater than 60 minutes, the organic components may be decomposed and release too much carbon dioxide into the atmosphere, so the calcium and carbonate in the bone char absorbent would become less, thereby reducing the adsorption capacity of the bone char absorbent for arsenic.

Then, as shown in a step 130 and a step 140 of FIG. 1, performing a cooling step on the torrefied bone material to form the bone char absorbent. In one embodiment, the cooling step is natural cooling. It should be noted that the above-mentioned torrefaction step is to place the dried bone material in a sealed crucible for heating (i.e., the torrefaction step). After the heating is completed, the lid of the crucible remains sealed without removing the crucible from the stove until the crucible and the torrefied bone material are cooled to room temperature. During the cooling step, as the temperature decreases, the carbon dioxide produced during the torrefaction step reacts significantly with the hydroxyl groups of the bone char matrix (i.e., hydroxyapatite) at lower temperatures, thereby producing carbonate within the bone char. Therefore, natural cooling and low-temperature environments are conducive to the generation of carbonate within the bone material. The reaction of carbon dioxide with hydroxyl groups, resulting in carbonate present in the bone char, is referred to as carbon dioxide sequestration.

Since organic components (such as tissue or blood) in the bone material usually decompose at the temperature of 400° C. to 600° C. to generate carbon dioxide, the high-temperature pyrolysis of 400° C. to 1000° C. increases the release of carbon dioxide. Specifically, increased carbon dioxide concentration within the reaction system or crucible elevates the internal air pressure, which may release most of the carbon dioxide into the environment, so the obtained bone char absorbent has less carbonate, thereby reducing the adsorption capacity of the bone char absorbent for arsenic. In addition, carbonate is unstable at high temperatures and forms primarily at lower temperatures (usually around 200° C. to 300° C.). Compared with the high-temperature pyrolysis method, the disclosed method of manufacturing the bone char absorbent uses the low-temperature torrefied temperature of 175° C. to 300° C., which is energy-saving, environmentally friendly, cost-effective, and highly efficient.

In some embodiments of the manufacturing method 100, a carbonate content of the bone char absorbent accounts for about 13% to about 22% of the bone char absorbent, such as about 14%, 15%, 16%, 17%, 18%, 19%, 20%, or 21%.

At least one embodiment of the present disclosure provides a bone char absorbent for adsorbing arsenic, in which the bone char absorbent is manufactured by the manufacturing method 100, an adsorption capacity of the bone char absorbent for trivalent arsenic ion in an arsenic solution is at least 2.5 mg per gram. In some embodiments, a pH value of the arsenic solution is between 3.5 and less than 7, such as 4.0, 4.5, 5, 5.4, 5.8, 6, 6.4, or 6.8. If the pH value of the arsenic solution was equal to or greater than 7, the carbonate and calcium ions in carbonated hydroxyapatite would not be dissolved in the arsenic solution and not be able to form vacancies, thereby the effect of adsorbing arsenic ions in the arsenic solution could not be achieved. In other words, when the pH value of the arsenic solution is between 3.5 and less than 7, the carbonate and calcium ions in the carbonated hydroxyapatite could be dissolved in the arsenic solution, and the arsenic ion in the arsenic solution could further occupy the original sites of carbonate and calcium ions, thereby achieving the effect of arsenic sorption. In some embodiments, an arsenic concentration of the arsenic solution is 25 mg/L.

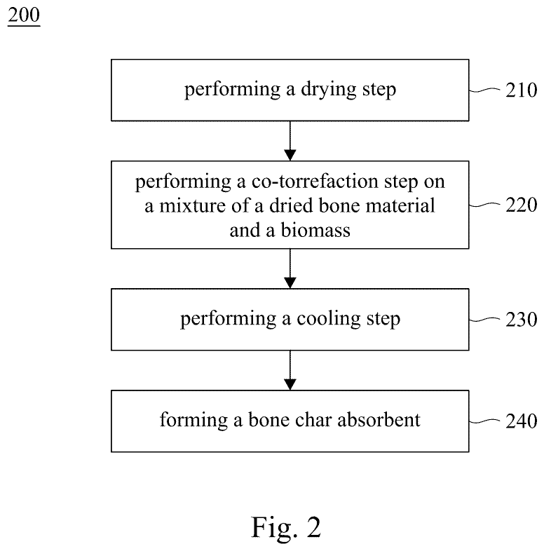

FIG. 2 is a flow chart of a method 200 of manufacturing a bone char absorbent in accordance with another aspect of the present disclosure. The differences between the method 100 in FIG. 1 and the method 200 in FIG. 2 are the torrefaction step 120 and a co-torrefaction step 220.

As shown in a step 210 of FIG. 2, performing a drying step on an initial bone material to form a dried bone material. The initial bone material in the step 210 of FIG. 2 is the same as the initial bone material in the step 110 of FIG. 1, and the details thereof are not repeatedly described. The above-mentioned crushing step and the above-mentioned cleaning step can be performed before the step 210.

Next, as shown in the step 220 of FIG. 2, performing a co-torrefaction step on a mixture of the dried bone material and biomass to form a co-torrefied mixture. In some embodiments, the biomass includes hemicellulose, such as wood, straw, corn cob, bamboo, or coffee ground, but is not limited to these. Hemicellulose decomposes at about 180° C. and produces a large amount of carbon dioxide, which helps to enter the carbonate into the bone char matrix (i.e., hydroxyapatite) during the low-temperature cooling and form the carbonated hydroxyapatite. In some embodiments, the biomass includes cellulose, hemicellulose, and lignin. Since hemicellulose decomposes at about 180° C., it is the primary source of carbon dioxide within this temperature range. In contrast, the contributions from cellulose and lignin are relatively minor.

In some embodiments, a weight ratio of the dried bone material to the biomass is 1:5 to 1:15 in the co-torrefaction step, such as 1:10. If the weight ratio of dried bone material to biomass was less than 1:5, the amount of carbon dioxide produced from the biomass would be relatively smaller. Lower carbon dioxide content results in a reduced amount of carbonate in the bone char absorbent, thereby reducing the adsorption capacity of the bone char absorbent for trivalent arsenic ion. If the weight ratio of dried bone material to biomass was greater than 1:15, a large amount of carbon dioxide would be produced. Increased carbon dioxide concentration within the reaction system or crucible elevates the internal air pressure, which may release most of the carbon dioxide into the environment, so the obtained bone char absorbent has less calcium and carbonate, thereby reducing the adsorption capacity of the bone char absorbent for arsenic.

In some embodiments, the co-torrefaction step is performed at a heating rate of 10° C./min to 20° C./min to a co-torrefied temperature of 175° C. to 300° C. for 15 minutes to 60 minutes. In some embodiments, the heating rate in the co-torrefaction step is 15° C./min. In some embodiments, the torrefied temperature in the co-torrefaction step is 238° C. In some embodiments, the holding time in the co-torrefaction step is 30 minutes. In one specific embodiment, the co-torrefaction step is performed at the heating rate of 15° C./min to the co-torrefied temperature of 300° C. for 30 minutes.

It is understood that the ranges of the heating rate, the torrefied temperature, and the holding time in the step 120 are the same as the ranges of the heating rate, the co-torrefied temperature, and the holding time in the method 200. Based on the same mechanisms and reasons, the specific characteristics of the heating rate, the co-torrefied temperature, and the holding time in the co-torrefaction step are the same as the heating rate, the torrefied temperature, and holding time in the torrefaction step, and the details thereof are not repeatedly described.

Then, as shown in a step 230 and a step 240 of FIG. 2, performing a cooling step on the co-torrefied mixture to form the bone char absorbent. In one embodiment, the cooling step is natural cooling. The cooling step in the step 230 of FIG. 2 is the same as the cooling step in the step 130 of FIG. 1, and the details thereof are not repeatedly described.

In some embodiments of the method 200, a carbonate content of the bone char absorbent accounts for about 12% to about 13% of the bone char absorbent, such as about 12.5%.

At least one embodiment of the present disclosure provides a bone char absorbent for adsorbing arsenic, in which the bone char absorbent is manufactured by the method 200, an adsorption capacity of the bone char absorbent for trivalent arsenic ion in an arsenic solution is at least 2.5 mg per gram. In some embodiments, a pH value of the arsenic solution is between 3.5 and less than 7, such as 4.0, 4.5, 5, 5.4, 5.8, 6, 6.4, or 6.8. If the pH value of the arsenic solution was equal to or greater than 7, the carbonate and calcium ions in carbonated hydroxyapatite would not be dissolved in the arsenic solution and not be able to form vacancies, thereby the effect of adsorbing arsenic ions in the arsenic solution could not be achieved. If the pH value of the arsenic solution is less than 3.5, the arsenic may desorb into the solution again after being adsorbed, thereby the effect of adsorbing arsenic ions in the arsenic solution could not be achieved. In some embodiments, an arsenic concentration in the arsenic solution is 25 mg/L.

The following Examples are used to describe the applications of the present disclosure, but they are not intended to limit the present disclosure.

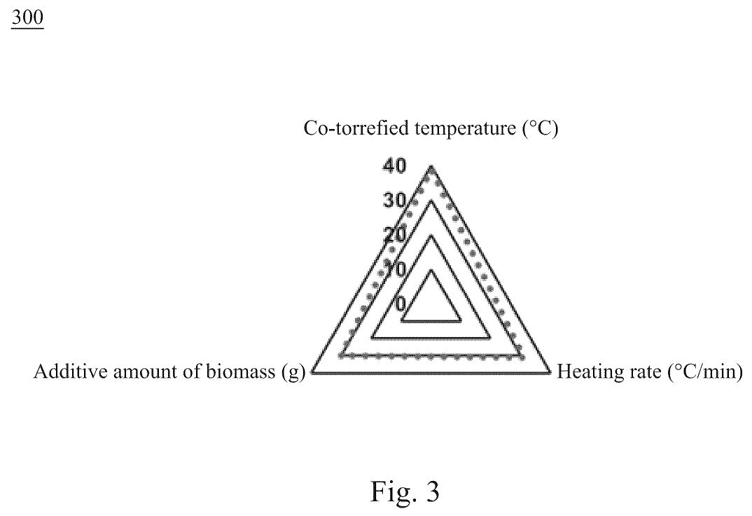

Before conducting Example 1 to Example 10, Taguchi optimization technology and artificial neural network (ANN) were used to determine which of the three parameters of heating rate, co-torrefied temperature, and additive amount of biomass was the most obvious parameter that affects carbonate substitution. FIG. 3 was a schematic diagram 300 illustrating the relative effect of process factors (including the heating rate, the co-torrefied temperature, and the additive amount of biomass). The results showed that the co-torrefied temperature had the greatest impact (38.8%) on carbonate substitution in bone char, the additive amount of biomass had the least impact (30.1%), and the heating rate had a moderate impact (31.06%).

### Example 1

In Example 1, 30 g of cattle bone was subjected to a cleaning step. Then, a crushing step was performed on the cattle bone to obtain an initial bone material, in which the mean diameter of the initial bone material was 1 mm to 2 mm. Next, a co-torrefaction step was performed on a mixture of 1 g of the dried bone material and 5 g of biomass (a weight ratio of the dried bone material to the biomass was 1:5) to form a co-torrefied mixture, in which the biomass was wood, and a mean diameter of the wood was less than 0.5 mm. The co-torrefaction step was performed at the heating rate of 10° C./min to the co-torrefied temperature of 175° C. for 30 minutes. Then, a cooling step was performed on the co-torrefied mixture to form a bone char absorbent, in which the cooling step was natural cooling. The specific process parameters of Example 1 are shown in Table 1 below.

After obtaining the bone char absorbent of Example 1, Attenuated Total Reflectance-Fourier Transform Infrared Spectroscopy (ATR-FTIR) was used to perform the semi-quantitative analysis on the bone char absorbent. The results showed that the carbonate fraction in the bone char absorbent of Example 1 was 14.56%, as shown in Table 1 below. It can be understood that three types of peaks, namely carbonate, phosphate, and amide, are observed in the FTIR spectrum. The proportion of carbonate was calculated by taking the total peak values of carbonate, phosphate, and amide as 100%.

TABLE 1

| | Mean | Additive | | | | | Carbonate | Adsorption |
|---|---|---|---|---|---|---|---|---|
| | diameter of | amount of | Additive | | | | fraction in bone | capacity of bone |
| | initial bone | dried bone | amount of | Heating | Heating | Holding | char absorbent | char absorbent for |
| | material | material | biomass | rate | temperature | time | after heat | trivalent arsenic |
| | [mm] | [g] | [g] | [° C./min] | [° C.] | [min] | treatment [%] | ions [mg/g] |
| Example 1 | 1~2 | 1 | 5 | 10 | 175 | 30 | 14.56 | N/A |
| Example 2 | 1~2 | 1 | 10 | 15 | 175 | 30 | 13.49 | N/A |
| Example 3 | 1~2 | 1 | 15 | 20 | 175 | 30 | 15.59 | N/A |
| Example 4 | 1~2 | 1 | 10 | 10 | 238 | 30 | 19.74 | N/A |
| Example 5 | 1~2 | 1 | 15 | 15 | 238 | 30 | 14.51 | N/A |
| Example 6 | 1~2 | 1 | 5 | 20 | 238 | 30 | 16.79 | N/A |
| Example 7 | 1~2 | 1 | 15 | 10 | 300 | 30 | 18.73 | N/A |
| Example 8 | 1~2 | 1 | 5 | 15 | 300 | 30 | 21.28 | at least 2.5 |
| Example 9 | 1~2 | 1 | 10 | 20 | 300 | 30 | 16.37 | N/A |
| Example 10 | 1~2 | 1 | No addition | 15 | 300 | 30 | 12.39 | at least 2.5 |
| Comparative | 1~2 | No disclose | No addition | 10 | 900 | 60 | 0 | about 0.07 |
| Example | | | | | | | | |

“N/A” means that arsenic adsorption experiment was not performed on this Example.

### Example 2 to Example 9

Example 2 to Example 9 were performed like Example 1. The differences between Example 1 to Example 9 were the additive amounts of biomass, the heating rate, and the heating temperature in the co-torrefaction step, in which the weight ratio of the dried bone material to the biomass was 1:5, 1:10, or 1:15, and the heating temperature was 175° C., 238° C., or 300° C. The specific process parameters and the carbonate fractions of Example 2 to Example 9 are shown in Table 1.

It should be noted that, compared with Example 1 to Example 7 and Example 9, the carbonate fraction (21.28%) in the bone char absorbent after co-torrefaction in Example 8 was the highest. Since a higher carbonate fraction is beneficial to the adsorption of arsenic, further arsenic adsorption experiment was performed on the bone char absorbent in Example 8.

In the arsenic adsorption experiment, the pH value of an arsenic solution was 5.4, and the arsenic concentration of the arsenic solution was 25 mg/L. Specifically, since As₂O₃ is only soluble in NaOH solution as Na₃AsO₃ salt, 1 ml of a 2 molar (M) NaOH solution was combined with As₂O₃ powder and more water was added until the concentration reached nearly 25 mg/L. Then, a few drops of HCl solution were used to adjust the pH to 5.4 (slightly acidic) and the volume of the solution to retain the final concentration of 25 mg/L.

It should be noted that when the pH value of the arsenic solution is between 3.5 and less than 7, the carbonate and calcium ions in the carbonated hydroxyapatite can be dissolved in the arsenic solution, and the arsenic ion in the arsenic solution can further occupy the original sites of carbonate and calcium ions, thereby achieving the effect of arsenic sorption. Therefore, the slightly acidic arsenic solution was used in the arsenic adsorption experiment. In addition, since the conditions of extremely low pH value (such as pH value below 4) are not common in the environment, the pH value used in the arsenic adsorption experiments of the present disclosure was set to 5.4.

As mentioned above, the arsenic concentration in Bangladesh's groundwater is as high as 0.2 mg/L. In the arsenic adsorption experiment, it was necessary to use an arsenic concentration higher than that typically found in the environment to observe the maximum adsorption capacity. Therefore, the arsenic concentration of the arsenic solution used in the arsenic adsorption experiment of the present disclosure was set to 25 mg/L.

After preparing the arsenic solution, 15 ml of the arsenic solution was poured into a 50 ml test tube. 5 g/L of the bone char absorbent was added to the 50 ml test tube. The test tube was shaken for 4 hours to achieve equilibrium. The samples were filtered using the Whatman No. 42 filter paper. The concentration of the trivalent arsenic ion in the filtered solution was determined using Inductively Coupled Plasma Mass Spectrometry (ICP-MS) (THERMO-ELEMENT XR) analysis.

The adsorption capacity was calculated using the following formula (III):

$$q = \frac{{C}_{0} - {C}_{f}}{m} \times v \qquad ( III )$$

in which q is the adsorption capacity, with units of “mg/g.” C₀ and C_{f} are the concentrations of trivalent arsenic ion in the initial and equilibrium solutions, respectively, with units of “mg/L.” v is the solution's volume, with units of “ml.” m is the absorbent's mass, with units of “g.”

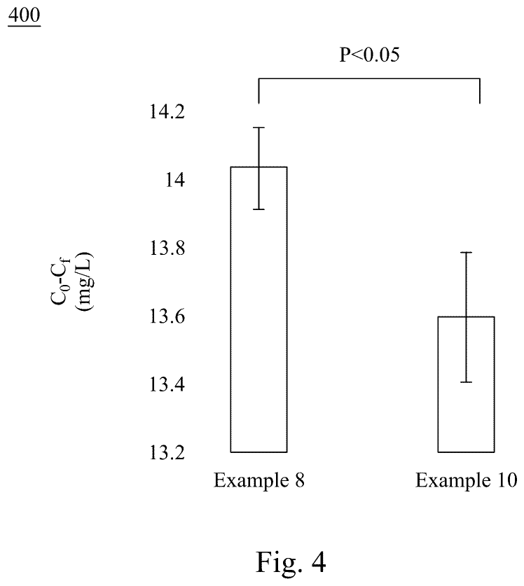

FIG. 4 was a bar chart 400 illustrating C₀-C_{f} in Example 8 and Example 10. It can be known from FIG. 4 that C₀-C_{f} in Example 8 was 14.04±0.12 mg/L. Calculated by the formula (III), the adsorption capacity of the bone char absorbent of Example 8 for trivalent arsenic ion was at least 2.5 mg per gram, as shown in Table 1 above.

### Example 10

No biomass was added to the dried bone material in Example 10, and 1 g of dried bone material was directly subjected to the torrefaction step. Since the process parameters in Example 8 were the most suitable conditions for conducting the arsenic adsorption experiment, Example 10 uses the same heating rate, heating temperature, and torrefaction time (holding time) as Example 8.

It can be known from FIG. 4 that C₀-C_{f} in Example 8 was 13.6±0.19 mg/L. Calculated by the formula (III), the carbonate fraction in the bone char absorbent of Example 10 was 12.39%, and the adsorption capacity of the bone char absorbent of Example 10 for trivalent arsenic ion was at least 2.5 mg per gram, as shown in Table 1 above.

### Comparative Example

Comparative Example was Alkurdi's disclosure. In Comparative Example, no biomass was added, and the sheep bone material was directly subjected to the torrefaction step. The torrefaction step was performed at the heating rate of 10° C./min to the heating temperature of 900° C. (pyrolysis temperature) for 60 minutes. The results showed that the carbonate fraction in the bone char absorbent of Comparative Example was 0%, and the adsorption capacity of the bone char absorbent of Comparative Example for trivalent arsenic ion was about 0.07 mg per gram, as shown in Table 1 above.

Since the high-temperature pyrolysis method was used in Comparative Example to form the bone char absorbent, the carbonate produced during the pyrolysis process was completely thermally pyrolyzed above 700° C. Therefore, the mineral phase generated by Alkurdi did not contain carbonate. Since the mineral phase generated by Alkurdi does not contain carbonate, its adsorption capacity for arsenic was poor.

It can be known from Example 1 to Example 10 and Comparative Example, compared with the bone char absorbent formed by high-temperature pyrolysis temperature, the bone char absorbent formed by low-temperature torrefied temperature/co-torrefied temperature can retain a certain proportion of carbonate fraction. As a result, the sorption capacities of the bone char absorbents of Example 8 and Example 10 for trivalent arsenic ion were significantly better than the adsorption capacity of the bone char absorbent of the Comparative Example for trivalent arsenic ion.

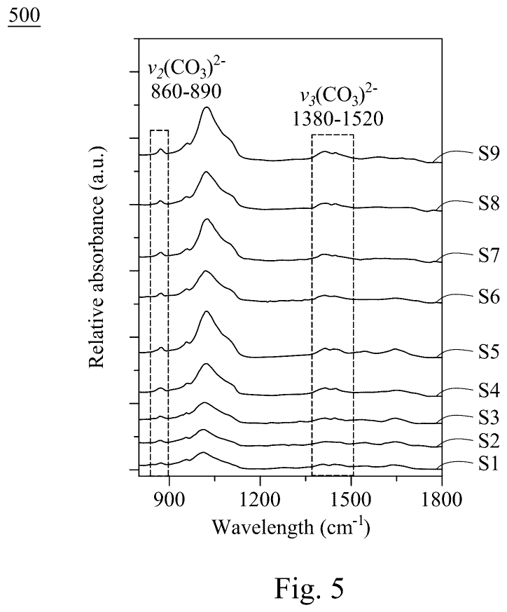

FIG. 5 was a graph 500 illustrating the results of Sample S1 to Sample S9 in Example 1 to Example 9 respectively before the arsenic adsorption experiment under ATR-FTIR to observe the carbonates contained in Sample S1 to Sample S9. The semi-quantitative analysis was used to calculate the percentages of carbonate content in the bone char absorbents, in which the carbonate includes v₂ CO₃²⁻ (the characteristic peak was at 860 cm⁻¹ to 890 cm⁻¹) and v₃ CO₃²⁻ (the characteristic peak was at 1380 cm⁻¹ to 1520 cm⁻¹). The carbonate fractions in the bone char absorbents after co-torrefaction are shown in Table 1 above.

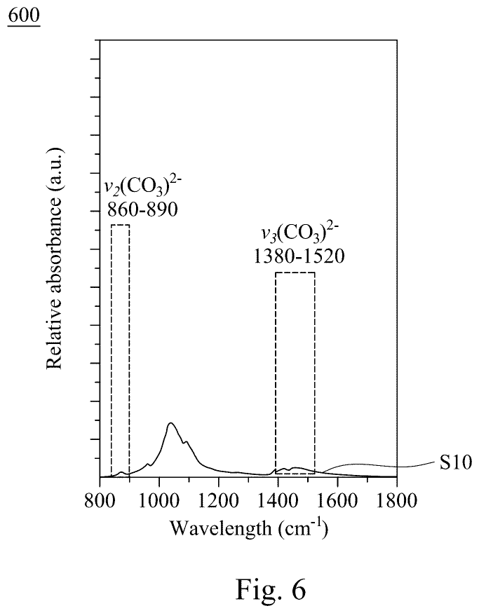

FIG. 6 was a graph 600 illustrating the result of Sample S10 in Example 10 before the arsenic adsorption experiment under ATR-FTIR to observe the carbonate contained in Sample S10. The semi-quantitative analysis was used to calculate the percentage of carbonate content in the bone char absorbent, in which the carbonate includes v₂ CO₃²⁻ (the characteristic peak was at 860 cm⁻¹ to 890 cm⁻¹) and v₃ CO₃²⁻ (the characteristic peak was at 1380 cm⁻¹ to 1520 cm⁻¹). The carbonate fraction in the bone char absorbent after torrefaction is shown in Table 1 above.

In summary, compared with the bone char absorbent obtained by using the high-temperature pyrolysis temperature (such as 400° C. to 1000° C.), the bone char absorbents of the present disclosure are obtained by using the low-torrefied temperature/co-calcination temperatures (such as 175° C. to 300° C.). The disclosed method of manufacturing the bone char absorbent is energy-saving, environmentally friendly, cost-effective, and highly efficient. The mineral phase of the disclosed bone char absorbents (i.e., torrefied/co-torrefied bone chars) includes carbonated hydroxyapatite. In the acidic solution, the carbonate and calcium ions in carbonated hydroxyapatite are released out of its chemical structure to form vacancies. Arsenic can then occupy these vacancies and form ionic bonds with phosphate, thereby achieving the effect of arsenic sorption.

It can be understood that the present disclosure used specific compositions, specific manufacturing methods, and specific evaluation methods as examples to describe the bone char absorbents and the method of manufacturing the same. However, any person with ordinary knowledge in the technology sector to which the present invention belongs will know that the present disclosure is not limited thereto. The present disclosure can also be implemented using other compositions, other manufacturing methods, or other evaluation methods without departing from the spirit and scope of the present disclosure.

The present disclosure has been disclosed as hereinabove; however, it is not used to limit the present disclosure. Those skilled in the art may make various changes, substitutions, and alterations herein without departing from the spirit and scope of the present disclosure. Therefore, the scope of protection of the present disclosure shall be subject to the scope of the claims attached in the application and its equivalent constructions.

What is claimed is:

1. A method of manufacturing a bone char absorbent, comprising:
performing a drying step on an initial bone material to form a dried bone material;
performing a torrefaction step on the dried bone material to form a torrefied bone material, wherein the torrefaction step is performed at a heating rate of 10° C./min to 20° C./min to a torrefied temperature of 175° C. to 300° C. for 15 minutes to 60 minutes; and
performing a cooling step on the torrefied bone material to form the bone char absorbent.

2. The method of manufacturing the bone char absorbent of claim 1, wherein a raw material of the initial bone material is a cattle bone or a pig bone.

3. The method of manufacturing the bone char absorbent of claim 1, wherein a mean diameter of the initial bone material is 1 mm to 2 mm.

4. The method of manufacturing the bone char absorbent of claim 1, wherein a drying temperature of the drying step is 50° C. to 100° C.

5. The method of manufacturing the bone char absorbent of claim 1, wherein a drying time of the drying step is 20 hours to 24 hours.

6. The method of manufacturing the bone char absorbent of claim 1, wherein the torrefaction step is performed at the heating rate of 15° C./min to the torrefied temperature of 300° C. for 30 minutes.

7. The method of manufacturing the bone char absorbent of claim 1, wherein the torrefied temperature in the torrefaction step is 238° C.

8. The method of manufacturing the bone char absorbent of claim 1, wherein the cooling step is natural cooling.

9. The method of manufacturing the bone char absorbent of claim 1, wherein a carbonate content of the bone char absorbent accounts for 13% to 22% of the bone char absorbent.

10. A bone char absorbent for adsorbing arsenic, wherein the bone char absorbent is manufactured by the method of manufacturing the bone char absorbent of claim 1, an adsorption capacity of the bone char absorbent for trivalent arsenic ion in an arsenic solution is at least 2.5 mg per gram, a pH value of the arsenic solution is between 3.5 and less than 7, and an arsenic concentration of the arsenic solution is 25 mg/L.

11. A method of manufacturing a bone char absorbent, comprising:
performing a drying step on an initial bone material to form a dried bone material;
performing a co-torrefaction step on a mixture of the dried bone material and a biomass to form a co-torrefied mixture, wherein the co-torrefaction step is performed at a heating rate of 10° C./min to 20° C./min to a co-torrefied temperature of 175° C. to 300° C. for 15 minutes to 60 minutes; and
performing a cooling step on the co-torrefied mixture to form the bone char absorbent.

12. The method of manufacturing the bone char absorbent of claim 11, wherein the biomass comprises hemicellulose.

13. The method of manufacturing the bone char absorbent of claim 11, wherein a weight ratio of the dried bone material to the biomass is 1:5 to 1:15 in the co-torrefaction step.

14. The method of manufacturing the bone char absorbent of claim 13, wherein the weight ratio of the dried bone material to the biomass is 1:10 in the co-torrefaction step.

15. The method of manufacturing the bone char absorbent of claim 11, wherein a drying temperature of the drying step is 50° C. to 100° C., and a drying time of the drying step is 20 hours to 24 hours.

16. The method of manufacturing the bone char absorbent of claim 11, wherein the co-torrefaction step is performed at the heating rate of 15° C./min to the co-torrefied temperature of 300° C. for 30 minutes.

17. The method of manufacturing the bone char absorbent of claim 11, wherein the torrefied temperature in the co-torrefaction step is 238° C.

18. The method of manufacturing the bone char absorbent of claim 11, wherein the cooling step is natural cooling.

19. The method of manufacturing the bone char absorbent of claim 11, wherein a carbonate content of the bone char absorbent accounts for 12% to 13% of the bone char absorbent.

20. A bone char absorbent for adsorbing arsenic, wherein the bone char absorbent is manufactured by the method of manufacturing the bone char absorbent of claim 11, an adsorption capacity of the bone char absorbent for trivalent arsenic ion in an arsenic solution is at least 2.5 mg per gram, a pH value of the arsenic solution is between 3.5 and less than 7, and an arsenic concentration of the arsenic solution is 25 mg/L.
